(19) United States
(12) Patent Application Publication
(10) Pub. No.: US 2005/0175111 A1
(43) Pub. Date: Aug. 11, 2005

(54) Broadband system models

(76) Inventors: Tom Dhaene, Deinze (BE); Luc Knockaert, Gent (BE)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/042,790

(22) Filed: Jan. 24, 2005

(30) Foreign Application Priority Data
Feb. 6, 2004 (GB) 04 02 612.6

(51) Int. Cl. H04B 1/18

(52) U.S. Cl. 375/259

(57) ABSTRACT

A method of concatenating a plurality of narrowband frequency-domain models of a linear time-invariant (LTI) system, each model being descriptive of the system's operational characteristics over a different respective frequency range, to derive a single broadband model that describes the system's operational characteristics over the total frequency range encompassed by the narrowband models, includes assembling stable poles of matrix representations of the narrowband frequency-domain models together with additional poles satisfying a predetermined criterion, based on band-limited truncated Complete Orthonormal Kautz Bases (COKB) requirements, to derive a canonical modal system matrix, deriving a band-limited controllability Grammian as a function of the canonical modal system matrix. deriving a broadband observability vector as a function of the band-limited controllability Grammian and the canonical modal system matrix, and deriving the single broadband model as a function of the broadband observability vector.

This invention relates to broadband system models, and particularly though not exclusively to methods and apparatus of concatenating a plurality of narrowband frequency-domain models of a linear time-invariant (LTI) system to derive a single broadband model that describes the system's operational characteristics over the total frequency range encompassed by the narrowband models.

### BACKGROUND ART

The use of system simulation techniques to design and analyse complex dynamic systems, incorporating mathematical descriptions of the characteristics of component parts of the systems, has become increasingly widespread. Examples include automotive and aerospace products, and electronic products such as mobile telephones and domestic receivers for satellite TV transmissions. This trend has been accompanied by an increase in the dynamic range over which such simulation techniques are required accurately to model the systems' behaviour. For example, some electronic circuits need to be designed for predictable operation over a frequency range from d.c. to 10 GHz or even 100 GHz. These systems are typically of a kind known as linear time-invariant (LTI), meaning that they comply with the principle of superposition and that time shifts in the input signal produce equal time shifts in the output signal.

Known simulation techniques include adaptive frequency sampling (AFS) (“Adaptive frequency sampling algorithm for fast and accurate S-parameter modelling of general planar structures”, T. Dhaene, J. Ureel, N. Fache & D. De Zutter, Proceedings of the IEEE International Microwave Symposium, May 1995) and narrow-band information methods (“Accurate computation of wide-band response of electromagnetic systems using narrowband information”, K. Kottapali, T. K. Sarkar, Y. Hua, E. K. Miller & G. J. Burke, IEEE Trans. Microwave Theory Techn, April 1991; and “Efficient frequency-domain modelling and circuit simulation of transmission lines”, L. M. Silveira, I. M. Elfadel, J. K. White, M. Chilukuri & K. S. Kundert, IEEE Trans. Components, Packaging and Manufacturing Technol., Part B: Advanced Packaging, vol. 17, no. 4, pp. 505-513, November 1994). Use of these techniques in actual circuit simulations generates multiple piecewise rational models, valid only over relatively small frequency ranges. However, further processing for example by means of SPICE (Simulation Program with Integrated Circuit Emphasis) netlists requires a single “global” rational model that is valid over the overall frequency range.

Prior proposals for solving the problem of building global broadband models based on multiple narrow-band rational approximations include:

1. A straightforward “brute-force” system identification approach, as described in “Identifying S-parameter models in the Laplace domain for high frequency multiport linear networks”, A. Verschueren, Y. Rolain, R. Vuerinckx & G. Vandersteen, Microwave Symposium Digest, 1998 IEEE MTT-S International, vol. 1, June 1998. This really consists of a mere re-sampling over the overall frequency range, without taking advantage of the known characteristics (poles, zeros, gains) of the piecewise rational models, and thereby loses track of pertinent information. This technique has the following practical disadvantages: it is a brute-force, computationally expensive method; there is no use of a-priori knowledge (poles/zeros, poles/residues); there are numerical stability issues if the system being modelled has a large number of poles; over-sampling (too many data samples) can occur; over-modelling (too many poles) is likely.

2. Complex Frequency Hopping (CFH), described in “Analysis of interconnect networks using complex frequency hopping (CFH)”, E. Chiprout & M. S. Nakhla, IEEE Trans. Computer-Aided Design, vol. 14, no. 2, pp. 186-200, February 1995. This is a heuristic technique that combines a relatively small set of dominant poles of multiple narrow-band frequency ranges into one global system model. CFH uses the concept of “moment matching” to obtain a lower-order multi-point Pade approximation. This technique likewise has practical disadvantages: it is based on heuristics and hard to apply automatically; only a subset of poles is considered; it has limited accuracy and it is not possible to estimate the accuracy of the approximating model generated.

### DISCLOSURE OF INVENTION

According to one aspect of this invention there is provided a method of concatenating a plurality of narrowband frequency-domain models of a linear time-invariant (LTI) system, each model being descriptive of the system's operational characteristics over a different respective frequency range, to derive a single broadband model that describes the system's operational characteristics over the total frequency range encompassed by the narrowband models, comprising the steps of:
assembling stable poles of matrix representations of the narrowband frequency-domain models together with additional poles satisfying a predetermined criterion, based on band-limited truncated Complete Orthonormal Kautz Bases (COKB) requirements, to derive a canonical modal system matrix;
deriving a band-limited controllability Grammian as a function of said canonical modal system matrix;
deriving a broadband observability vector as a function of said band-limited controllability Grammian and said canonical modal system matrix; and
deriving said single broadband model as a function of said broadband observability vector.

According to another aspect of this invention there is provided apparatus for concatenating a plurality of narrowband frequency-domain models of a linear time-invariant (LTI) system, each model being descriptive of the system's operational characteristics over a different respective frequency range, to derive a single broadband model that describes the system's operational characteristics over the total frequency range encompassed by the narrowband models, comprising:
a matrix generator for assembling stable poles of matrix representations of the narrowband frequency-domain models together with additional poles satisfying a predetermined criterion, based on band-limited truncated Complete Orthonormal Kautz Bases (COKB) requirements, to derive a canonical modal system matrix;
a Grammian generator for deriving a band-limited controllability Grammian as a function of said canonical modal system matrix;
a vector generator for deriving a broadband observability vector as a function of said band-limited controllability Grammian and said canonical modal system matrix; and
a model generator for deriving said single broadband model as a function of said broadband observability vector.

The invention accomplishes its purpose in part by making use of a novel, band-limited variant of Complete Orthonormal Kautz Bases (COKB). These Bases have been previously described for use in continuous-time system modelling (“Orthonormal basis functions for modelling continuous-time systems”, H. Akcay & B. Ninness, Signal Processing, vol. 77, no. 3, pp. 261-274, September 1999) and system identification (“System identification using Kautz models”, B. Wahlberg, IEEE Trans. Aut. Control, vol. 39, pp. 1276-1281, 1994). However, a major drawback of the COKB as previously described is that full frequency-domain knowledge is needed in order to calculate the pertinent Hardy space scalar products, whereas most often in practice essentially band-limited functions and systems are encountered. The inventors hereof have succeeded in developing a novel, truncated implementation of COKB, allowing the derivation of orthonormal band-limited Kautz sequences.

According to a further aspect of this invention, therefore, there is provided a method of modelling a linear time-invariant system, wherein a model of the system is constructed incorporating a set of stable poles generated using an α-band-limited truncated Complete Orthonormal Kautz Bases (COKB) sequence defined by

$$\begin{matrix}{Ξ}_{n} ( s ) = \sqrt{- 2 ℛ ( {p}_{n} )} \frac{α ( s + α )}{{α}^{2} s - {p}_{n} ( {s}^{2} + {α}^{2} )} {\prod }_{k = 0}^{n - 1} ( \frac{{α}^{2} s + \overline{{p}_{k}} ( {s}^{2} + {α}^{2} )}{{α}^{2} s - {p}_{k} ( {s}^{2} + {α}^{2} )} ) \\ n = 0.1 .2 … \end{matrix}$$

where R indicates the real part of a complex expression, Π indicates the product of the specified series of factors, α is the overall bandwidth, s is the complex frequency, and pₙ are the original poles.

### BRIEF DESCRIPTION OF DRAWINGS

A method and apparatus in accordance with this invention, for simulating operation of an LTI system such as an electronic circuit, will now be described, by way of example, with reference to the accompanying drawings, in which:

FIG. 1 is a block diagram of apparatus for simulating operation of an LTI system using the present invention;

FIG. 2 is a flow chart of a procedure implemented in the apparatus of FIG. 1;

FIG. 3 is a Bode diagram of the frequency response of a set of Butterworth filters modelled using the invention, showing simulation results provided by an initial approximation;

FIG. 4 is a Bode diagram of the frequency response of the set of Butterworth filters of FIG. 3, showing simulation results provided after a reduced order modelling step;

FIG. 5 is a Bode diagram of the frequency response of a pure delay transfer function modelled using the invention, showing simulation results provided by an initial approximation; and

FIG. 6 is a Bode diagram of the frequency response of the pure delay transfer function of FIG. 5, showing simulation results provided after a reduced order modelling step.

### DETAILED DESCRIPTION

The invention enables broadband system models to be assembled from two or more narrowband frequency-domain models of a linear time-invariant (LTI) system. A linear system is one to which the principle of superposition applies, i.e. the output of the system in response to two different stimuli applied simultaneously is equal to the sum of the system outputs in response to the two stimuli applied individually. Thus if:
x₁→y₁ and x₂→y₂
where x₁ and x₂ are system inputs, y₁ and y₂ are the system outputs, and → indicates “results in the response”, then in a linear system:
ax₁+bx₂→ay₁+by₂
where a and b are arbitrary constants.

A system is time-invariant if time shifts in the input signal produce equal time shifts in the output signal. Thus if:
x(t)→y(t)
then in a time-invariant system, for any time shift t₀:
x(t−t₀)→y(t−t₀)

Examples of LTI systems are found in a variety of disciplines: electronic circuits such as satellite microwave receivers, radio-frequency and microwave circuits; mechanical systems such as oscillators (e.g. vehicle suspensions and other sprung systems) and disk drives; electrical power systems, such as transformers; computer systems; biological systems; and economic systems.

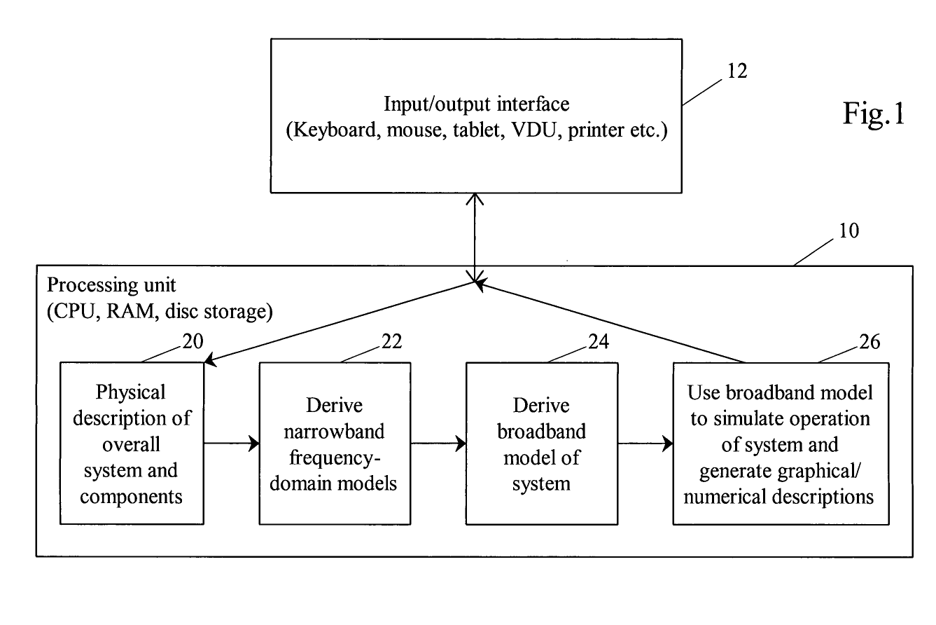

For convenience an example implementation of the invention will be described in the context of electronic circuit design, using apparatus as shown in FIG. 1 for simulating operation of an electronic circuit. However, the invention is equally applicable to simulating the operation of any other kind of LTI system, including those mentioned above.

Referring to FIG. 1, the apparatus comprises a processing unit 10 and a user input/output interface unit 12. The processing unit 10 includes a central processing unit (CPU), random-access memory (RAM), hard disc storage and associated circuitry to enable the CPU to implement procedures in accordance with software program instructions stored in the RAM, and to interact with the interface unit 12 to receive input from the user and display the results of the procedures. The interface unit 12 typically comprises a visual-display unit (VDU), keyboard, mouse and/or tablet or similar pointing device, and a printer or other hard-copy output device.

In preparing to perform a system simulation, the apparatus receives, via the interface unit 12, a physical description of the system at step 20, for example a list of components of an electronic circuit, their operating characteristics (e.g. resistance, capacitance, gain as a function of frequency, etc.), their interconnection and other details of the circuit layout. At step 22 the apparatus derives a plurality of narrowband frequency-domain models of the system's operation. The number of models will depend in particular on the frequency range over which the operation of the system is to be simulated. These models may conveniently be in state-space format, comprising (in generalised terms): a state equation of the form
x′=Ax+Bu
where x′ (bold type indicates a matrix or vector) is the derivative of the system's state vector with respect to time, A is the system matrix, B is the input matrix and u is the input; and an output equation of the form
y=Cx+Du
where y is the output, C is the output matrix, and D is the feedforward term.

At step 24 the plurality of narrowband models is used to derive a single broadband model of the system's behaviour over the entire frequency range of interest, as described in more detail herein. At step 26 the broadband model is used to simulate operation of the system and generate output data that describes such operation. These output data may comprise, for example, graphical displays of circuit operating characteristics, such as Bode diagrams, Smith charts and pole-zero diagrams, and numerical descriptions such as parameter values for formulae that summarise the system's properties. The output data are supplied to the user via the interface unit 12, and may be used to understand the operating characteristics of the simulated system, compare its behaviour with that which is desired, refine the design of the system, and provide data to control manufacturing processes to assemble a practical implementation of the system.

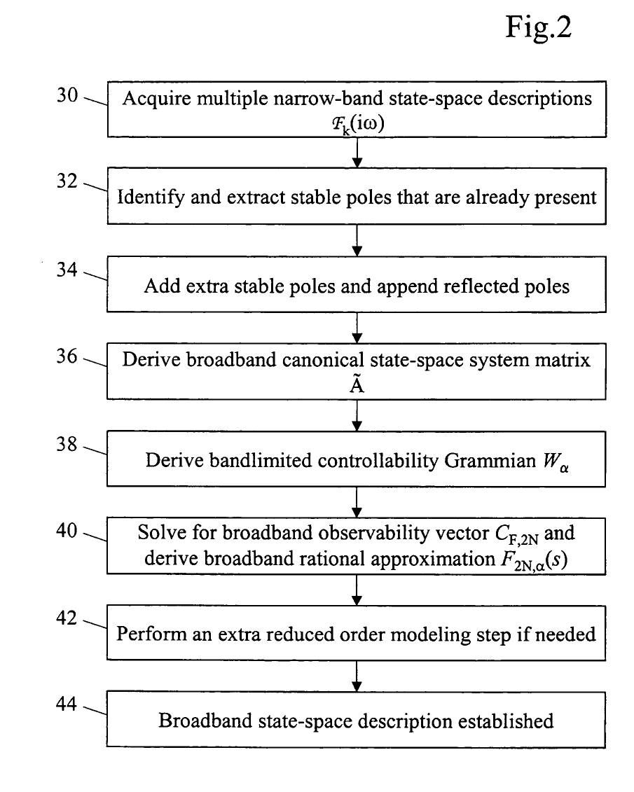

The operation of the apparatus in relation to steps 20 and 22 is conventional, and need not be described further here. The derivation of a single broadband model proceeds as summarised in FIG. 2. At step 30 a plurality M of piecewise, narrowband state-space descriptions Fₖ(iω) is acquired, using conventional techniques as described above. These descriptions may be summarised as
F(iω)=Fₖ(iω)=Cₖ^{T}(iωI−Aₖ)⁻¹Bₖ 0≦ₖ≦|ω|≦βₖ k=1 . . . M (1)
with 0<βₖ≦γₖ₊₁ and β_{M}=α, where α is the overall bandwidth of the desired single broadband model and ω is the radial frequency. The objective is to obtain a single rational approximation that well matches all the piecewise, band-limited functions Fₖ(iω) over the frequency range [−α, α]. As explained below, this rational approximation takes the form

$${F}_{2 N , α} ( s ) = {\sum }_{n = 0}^{2 N - 1} {〈 F \vert {\tilde{ξ}}_{n} 〉}_{α} {\tilde{ξ}}_{n} ( s ) = {{\tilde{C}}_{F , 2 N}^{T} ( s I - \tilde{A} )}^{- 1} \tilde{B} \qquad ( 2 )$$

To obtain this overall rational approximation F_{2N,α}(s), an appropriate stable pole segment that is already present in the piecewise data is first selected, at step 32. A description of how to perform this individual step is given in the above-mentioned paper by Dhaene, Ureel, Fache & De Zutter. A first and straightforward requirement for accomplishing it is to include the set of all the stable poles of the matrices Aₖ in the {qₖ} pole sequence of the broadband representation. To further enhance the dynamic range, this pole segment is extended at step 34 by a truncated sequence of other stable poles satisfying the Müntz-Szász condition (see “Equivalent formulations of the Muntz-Szasz completeness condition for systems of complex exponentials”, L. Knockaert, Journal of The Franklin Institute, vol. 339, no. 1, pp 103-109, January 2002). One possibility is a sequence of equal Laguerre poles {−α; k=1, . . . , L}; another possibility, particularly where it is desired to avoid degeneracy problems related to coinciding poles, is a sequence of the form {−kα/(k+1); k=1, . . . , L}; further details of such sequences are given in “On orthonormal Muntz-Laguerre filters”, L. Knockaert, IEEE Trans. on Signal Processing, vol. 49, no. 4, pp. 790-793, April 2001. The full pole segment being assembled at step 34 is obtained by appending the reflected pole set {α²/qₖ}. The reflected poles enable compliance with the α-band-limited truncated Complete Orthonormal Kautz Bases (band-limited truncated COKB) requirements that have been derived for the first time by the inventors hereof:

$$\begin{matrix}{Ξ}_{n} ( s ) = \sqrt{- 2 ℛ ( {p}_{n} )} \frac{α ( s + α )}{{α}^{2} s - {p}_{n} ( {s}^{2} + {α}^{2} )} {\prod }_{k = 0}^{n - 1} ( \frac{{α}^{2} s + \overline{{p}_{k}} ( {s}^{2} + {α}^{2} )}{{α}^{2} s - {p}_{k} ( {s}^{2} + {α}^{2} )} ) \\ n = 0.1 .2 … \end{matrix} \qquad ( 3 )$$

where R indicates the real part of a complex expression, Π indicates the product of the specified series of factors, α is the overall bandwidth, s is the complex frequency, and pₙ are the original poles.

At step 36 a broadband canonical modal state-space system matrix Ã is constructed, by combining all the stable poles {qₖ} of the matrices Aₖ (system matrices) of the state-space representations Fₖ(iω), plus the stable poles {−kα/(k+1); k=1, . . . , L}, plus the reflected poles {α²/qₖ}appended in step 34, which depend only on the previously-generated full pole sequences (of step 32).

At step 38 a band-limited controllability Grammian W_{α} is derived from the piecewise, narrowband state-space descriptions F(iω) acquired at step 30, by way of narrowband scalar products as described below. The controllability Grammian is a known concept in state-space description of systems, providing information on whether there exists a system input for any initial state of the system that will bring it to some other defined state in a defined time interval. The band-limited controllability Grammian W_{α} is derived at step 38 according to the expression
W_{α}=<(iωI−Ã)⁻¹\tilde{B}|[(iωI−Ã)⁻¹\tilde{B}]^{T}>_{α} (4)
where Ã is the 2N×2N broadband state-space system matrix obtained at step 36 and \tilde{B} is a column vector of length 2N consisting of only ones.

A narrowband (α-band-limited) scalar product of LTI state-space transfer functions such as that in expression (4) above, represented by the notation “<.|.>_{α}”, can be efficiently computed by using the relationship

$${〈 {F}_{1} \vert {F}_{2} 〉}_{α} = - \frac{1}{π} {C}_{12}^{T} arc cot ( \frac{{A}_{12}}{α} ) {B}_{12} \qquad ( 5 )$$

where F₁ and F₂ are the state-space transfer functions whose scalar product is required (for example of the form [C₁^{T}(iωI−A₁)⁻¹B₁] and [C₂^{T}(iωI−A₂)⁻¹B₂]), C^{T} indicates the transpose of the matrix C, arccot is the arc-cotangent function, and A₁₂, B₁₂ and C₁₂ are matrices derived from these functions:

$${C}_{12} = ( \begin{matrix}0 \\ {C}_{2}\end{matrix} ) {B}_{12} = ( \begin{matrix}{B}_{1} \\ 0\end{matrix} ) {A}_{12} = ( \begin{matrix}{A}_{1} & 0 \\ - {B}_{2} {C}_{1}^{T} & - {A}_{2}\end{matrix} ) \qquad ( 6 )$$

In applying expression (5) to the evaluation specifically of expression (4), C₁^{T} and C₂^{T} each take on the value of the diagonal identity matrix. The computation of the expression arccot(A), where A is any real matrix, can be accomplished using a method devised by B. N. Parlett and described in “Matrix Computations” by G. H. Golub & C. F. Van Loan, The John Hopkins University Press, 1996, section 11.1, pp. 380-387.

The band-limited controllability Grammian W_{α} derived at step 38 is then used in step 40 to evaluate a broadband observability vector C_{F,2N}, according to the following relationship

$${\tilde{C}}_{F , 2 N} = {W}_{α}^{- 1} ℛ \{ {〈 {( ⅈω - \tilde{A} )}^{- 1} \tilde{B} \vert F ( ⅈ ω ) 〉}_{α} \} \qquad ( 7 )$$

where R indicates the real part of the complex expression between braces { }. The scalar product in this complex expression can be evaluated using the relationship (5) as described above.

The required rational approximation of a single, broadband state-space model of the system to be simulated can then be derived using expression (2) given above.

As a consequence of the manner of construction of the system matrix Ã at step 36, the function for F_{2N,α}(s) on the right-hand side of expression (2) may have an excessively large model order (number of poles). Therefore at optional step 42 the state-space representation of F_{2N,α}(s) may be input into a reduced order modelling algorithm such as the Laguerre-SVD algorithm, described in “Laguerre-SVD reduced order modeling”, L. Knockaert & D. De Zutter, IEEE Trans. Microwave Theory Techn., vol. 48, no. 9, pp. 1469-1475, September 2000, to obtain at step 44 a final broadband state-space model of sufficiently low order.

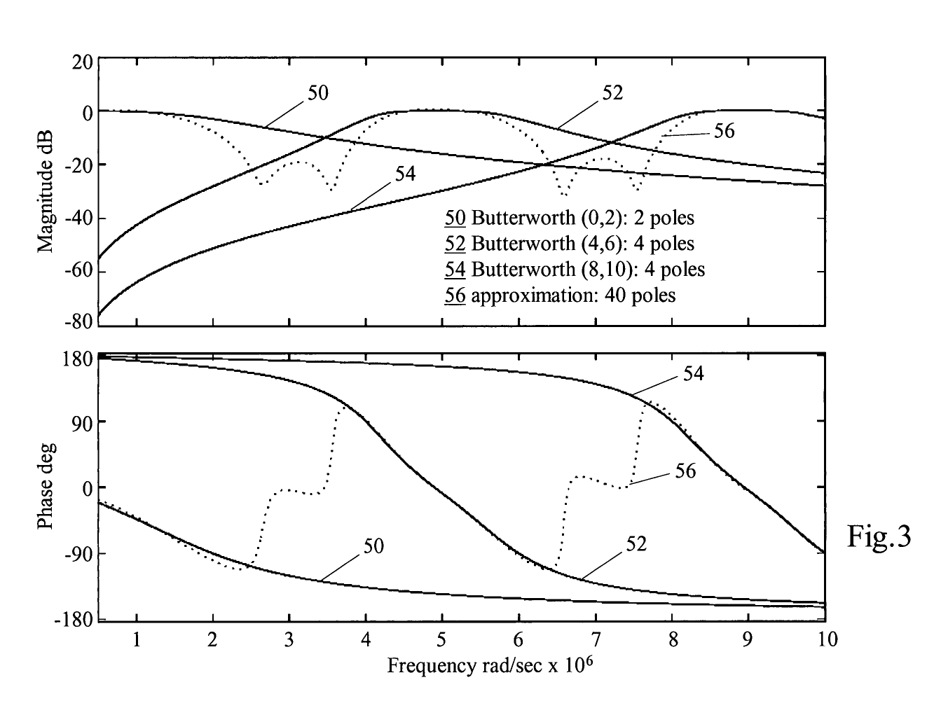

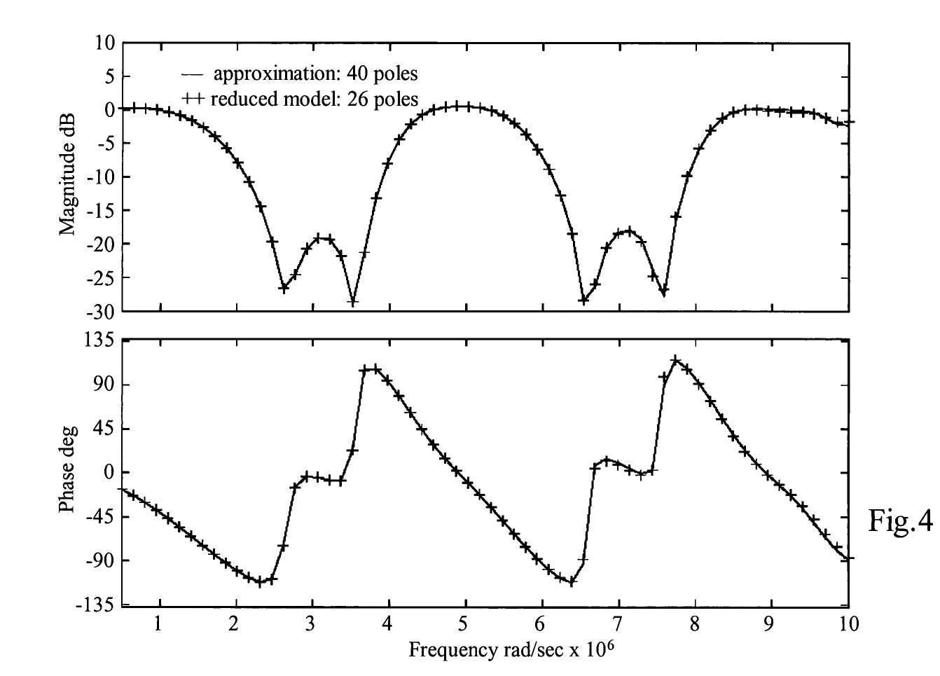

An example of the invention applied to the modelling of a system comprising three Butterworth filters will be described: the first filter is two-pole, low-pass with cutoff ω_{c}=2×10⁶ rad/s; the second is four-pole, band-pass over the frequency range 4×10⁶ rad/s≦ω≦6×10⁶ rad/s; and the third is four-pole, band-pass over the higher range 8×10⁶ rad/s≦ω≦10⁷ rad/s. The purpose is to find a single (global) state-space model which is sufficiently close to each of the three filters considered individually in its respective frequency band. The global bandwidth α=10⁷ rad/s and the number of stable poles is 10. Adding 10 approximate Laguerre poles {−α/2, −2α/3, . . . , −10 α/11} and reflecting the poles by means of the transformation α²/p (step 34) results in a total of 40 system poles to include in the global model. Applying the procedure described with reference to steps 38 and 40, using the arccot relationship (4), results in a value for the observability vector C_{F,2N}, and an initial global state-space description. A Bode diagram of this description is shown in FIG. 3, where the continuous lines 50, 52 and 54 indicate the characteristics of the component Butterworth filters, and the dotted line 56 indicates the characteristics of the global state-space model. After a Laguerre-SVD reduced order modelling step 42 (FIG. 2), an accurate reduced-order model with 26 system poles is obtained, with characteristics as shown in the Bode diagram of FIG. 4 (which covers a more restricted range of magnitude and phase than FIG. 3).

Sometimes a Neville-type rational interpolation procedure such as the Bulirsch-Stoer algorithm (described in “Numerical Recipes in Fortran, The Art of Scientific Computing”, W. H. Press, S. A. Teukolsky, W. T. Vetterling & B. P. Flannery, 2nd Ed., Cambridge University Press, 1992) can be used to find a rational function that is close to a tabulated function over a certain frequency range. A convenient version of this algorithm, similar though not identical to the one presented in “An efficient adaptive frequency sampling algorithm for model-based parameter estimation as applied to aggressive space mapping”, R. Lehmensiek & P. Meyer, Microwave Opt. Techn. Lett., vol. 24, no. 1, pp. 71-78, January 2000, is as follows:
Consider a frequency response table h={H₁, \overline{H₁}, K, H_{N}, \overline{H_{N}}} at the complex frequencies {si=iω₁, s₂=−iω₁, . . . , s_{2N-1}=iω_{N}, s_{2N}=−iω_{N}} with 0<ω₁< . . . <ω_{N}<∞. Then a real-ratio function R_{2N}(s)=a_{2N}(s)/b_{2N}(s) with N poles and N-1 zeros such that R_{2N}(sₖ)=hₖ can be constructed by the Neville-type algorithm
aₖ(s)=σₖaₖ₋₁(s)+(s−sₖ₋₁)aₖ₋₂(s) (8)
bₖ(s)=σₖbₖ₋₁(s)+(s−sₖ₋₁)bₖ₋₂(s) (9)
with initial values a₀=0, a₁=h₁, b₁=b₀=1. The value for σₖ is found by requiring that hₖ=aₖ(sₖ)/bₖ(sₖ), i.e.

$${σ}_{k} = ( {s}_{k - 1} - {s}_{k} ) \frac{{h}_{k} {b}_{k - 2} ( {s}_{k} ) - {a}_{k - 2} ( {s}_{k} )}{{h}_{k} {b}_{k - 1} ( {s}_{k} ) - {a}_{k - 1} ( {s}_{k} )} \qquad ( 10 )$$

It would be convenient if the above interpolation algorithm also exhibited some extrapolation power, but unfortunately in practice this is rarely the case. To obtain a rational approximation of a given analytic function over a large bandwidth, we therefore need to interpolate over different relatively narrow bands, and afterwards combine the approaches in an overall rational model.

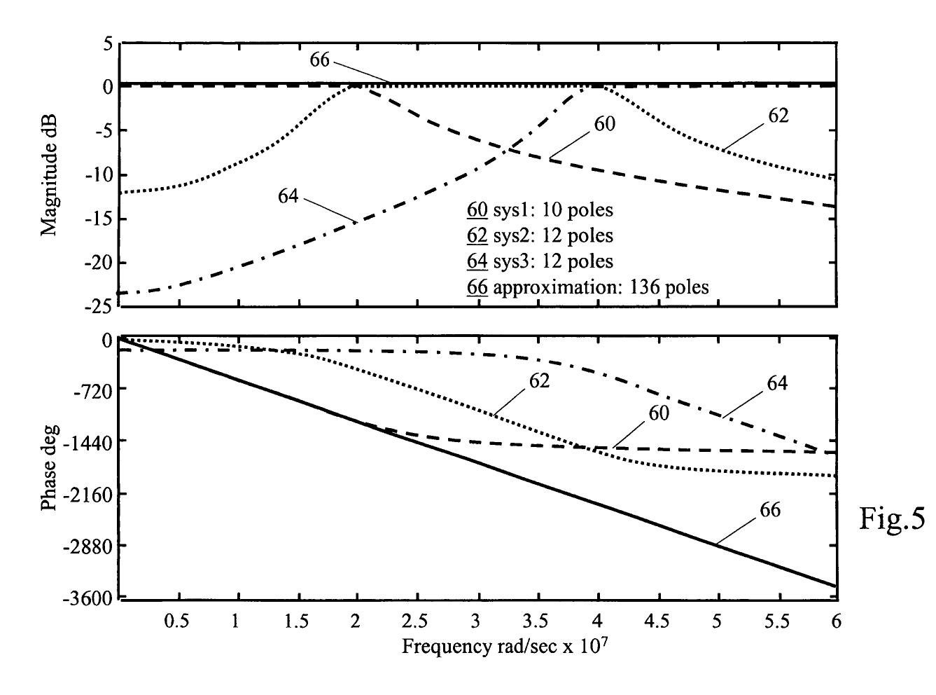

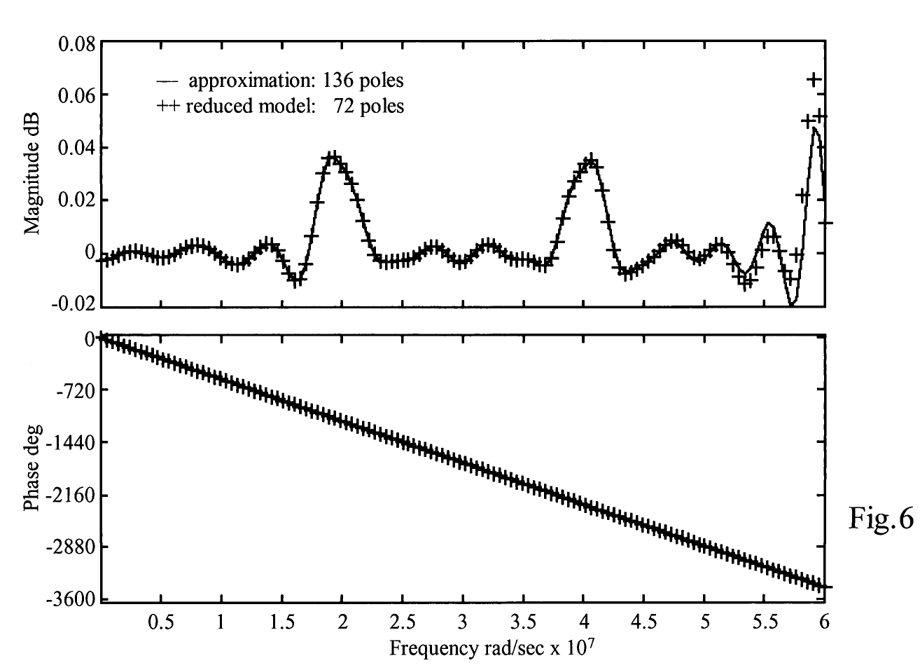

As an example, consider the pure delay transfer function e^{-st} with τ=1 μs. Applying the Neville-type algorithm on equispaced samples in the bands 0<ω≦2×10⁷ rad/s, 2×10⁷ rad/s≦ω≦4×10⁷ rad/s, and 4×10⁷ rad/s≦ω≦6×10⁷ rad/s, rational interpolants are obtained with respectively 10, 12 and 12 poles. The global bandwidth α=6×10⁷ rad/s and the number of stable poles is 34. Adding 34 approximate Laguerre poles {−α/2, −2α/3, . . . , −34α/35} and reflecting the poles by means of the transformation α^{2/}p (step 34 in FIG. 2) results in a total of 136 system poles to process. Applying the procedure described with reference to steps 38 and 40, using the arccot relationship (4), results in a value for the observability vector C_{F,2N}, and an initial global state-space description. A Bode diagram is shown in FIG. 5, where the discontinuous lines 60, 62 and 64 indicate the magnitude and phase characteristics of the three sets of rational interpolants, and the continuous line 66 indicates the characteristics of the global state-space model. (In the magnitude diagram the line 66 has been displaced fractionally upwards from its true position to make the interpolant lines that it overlaps more clearly visible.) After a Laguerre-SVD reduced order modelling step 42 (FIG. 2), an accurate reduced-order model with 72 system poles is obtained, with characteristics as shown in the Bode diagram of FIG. 6. In comparing FIGS. 5 and 6 it should be noted that the magnitude diagram in FIG. 5 embraces a range of +5 to −25 dB, whereas the magnitude range in FIG. 6 is much more restricted (+0.08 to −0.02 dB) to make subtle variations in magnitude response more evident.

1. A method of concatenating a plurality of narrowband frequency-domain models of a linear time-invariant (LTI) system, each model being descriptive of the system's operational characteristics over a different respective frequency range, to derive a single broadband model that describes the system's operational characteristics over the total frequency range encompassed by the narrowband models, comprising the steps of:
assembling stable poles of matrix representations of the narrowband frequency-domain models together with additional poles satisfying a predetermined criterion, based on band-limited truncated Complete Orthonormal Kautz Bases (COKB) requirements, to derive a canonical modal system matrix;
deriving a band-limited controllability Grammian as a function of said canonical modal system matrix;
deriving a broadband observability vector as a function of said band-limited controllability Grammian and said canonical modal system matrix; and
deriving said single broadband model as a function of said broadband observability vector.

2. The method of claim 1, including the step of applying a reduced order algorithm to said broadband model to reduce the number of poles.

3. The method of claim 2, wherein said reduced order algorithm is a Laguerre-SVD algorithm.

4. The method of claim 1, wherein the narrowband scalar products of LTI state-space transfer functions are derived in accordance with the expression
$${〈 {F}_{1} \vert {F}_{2} 〉}_{α} = - \frac{1}{π} {C}_{12}^{T} arc cot ( \frac{{A}_{12}}{α} ) {B}_{12}$$
where F₁ represents a first state-space transfer function, of the form [C₁^{T}(iωI−A₁)⁻¹B₁];
F₂ represents a second state-space transfer function, of the form [C₂^{T}(iωI−A₂)⁻¹B₂];
α is the total frequency range of the single broadband model;
C^{T} represents the transpose of a matrix C;
arccot is the arc-cotangent function; and
A₁₂, B₁₂ and C₁₂ are matrices derived from the functions:
$${C}_{12} = ( \begin{matrix}0 \\ {C}_{2}\end{matrix} ) {B}_{12} = ( \begin{matrix}{B}_{1} \\ 0\end{matrix} ) {A}_{12} = ( \begin{matrix}{A}_{1} & 0 \\ - {B}_{2} {C}_{1}^{T} & - {A}_{2}\end{matrix} )$$

5. The method of claim 1, wherein the band-limited controllability Grammian W_{α} is derived in accordance with the expression
W_{α}=<(iωI−Ã)⁻¹\tilde{B}|[(iωI−Ã)⁻¹\tilde{B}]^{T}>_{α}
where Ã is a 2N×2N broadband state-space system matrix and \tilde{B} is a column vector of length 2N consisting of only ones.

6. The method of claim 1, wherein the broadband observability vector is derived in accordance with the expression
$${\tilde{C}}_{F , 2 N} = {W}_{α}^{- 1} ℜ \{ {〈 {( ⅈω - \tilde{A} )}^{- 1} \tilde{B} \vert F ( ⅈω ) 〉}_{α} \}$$
where W_{α} is the band-limited controllability Grammian;
R indicates the real part of the complex expression between braces { };
Ã is a 2N×2N broadband state-space system matrix;
\tilde{B} is a column vector of length 2N consisting of only ones; and
<.|.>_{α} indicates an ax-band-limited scalar product of state-space transfer functions.

7. The method of claim 1, wherein the broadband model is derived in accordance with the expression
$${F}_{2 N , α} ( s ) = {\sum }_{n = 0}^{2 N - 1} {〈 F \vert {\tilde{ξ}}_{n} 〉}_{α} {\tilde{ξ}}_{n} ( s ) = {{\tilde{C}}_{F , 2 N}^{T} ( s I - \tilde{A} )}^{- 1} \tilde{B}$$
where C^{T}_{F,2N} is the broadband observability vector;
Ã is a 2N×2N broadband state-space system matrix; and
\tilde{B} is a column vector of length 2N consisting of only ones.

8. The method of claim 1, wherein a set of stable poles is generated using an α-band-limited truncated Complete Orthonormal Kautz Bases (COKB) sequence defined by
$${Ξ}_{n} ( s ) = \sqrt{- 2 ℜ ( {p}_{n} )} \frac{α ( s + α )}{{α}^{2} s - {p}_{n} ( {s}^{2} + {α}^{2} )} {\prod }_{k = 0}^{n - 1} ( \frac{{α}^{2} s + \overline{{p}_{k}} ( {s}^{2} + {α}^{2} )}{{α}^{2} s - {p}_{k} ( {s}^{2} + {α}^{2} )} )$$
$$n = 0 , 1 , 2 …$$
where R indicates the real part of a complex expression, Π indicates the product of the specified series of factors, α is the overall bandwidth, s is the complex frequency, and pₙ are the original poles.

9. Apparatus for concatenating a plurality of narrowband frequency-domain models of a linear time-invariant (LTI) system, each model being descriptive of the system's operational characteristics over a different respective frequency range, to derive a single broadband model that describes the system's operational characteristics over the total frequency range encompassed by the narrowband models, comprising:
a matrix generator for assembling stable poles of matrix representations of the narrowband frequency-domain models together with additional poles satisfying a predetermined criterion, based on band-limited truncated Complete Orthonormal Kautz Bases (COKB) requirements, to derive a canonical modal system matrix;
a Grammian generator for deriving a band-limited controllability Grammian as a function of said canonical modal system matrix;
a vector generator for deriving a broadband observability vector as a function of said band-limited controllability Grammian and said canonical modal system matrix; and
a model generator for deriving said single broadband model as a function of said broadband observability vector.

10. A method of modelling a linear time-invariant (LTI) system, wherein a model of the system is constructed incorporating a set of stable poles generated using an a-band-limited truncated Complete Orthonormal Kautz Bases (COKB) sequence defined by
$${Ξ}_{n} ( s ) = \sqrt{- 2 ℜ ( {p}_{n} )} \frac{α ( s + α )}{{α}^{2} s - {p}_{n} ( {s}^{2} + {α}^{2} )} {\prod }_{k = 0}^{n - 1} ( \frac{{α}^{2} s + \overline{{p}_{k}} ( {s}^{2} + {α}^{2} )}{{α}^{2} s - {p}_{k} ( {s}^{2} + {α}^{2} )} )$$
$$n = 0 , 1 , 2 …$$
where R indicates the real part of a complex expression, Π indicates the product of the specified series of factors, α is the overall bandwidth, s is the complex frequency, and pₙ are the original poles.
